(19) United States
(12) Patent Application Publication
(10) Pub. No.: US 2017/0287452 A1
(43) Pub. Date: Oct. 5, 2017

(54) DRUM HEAD WITH A PLURALITY OF CUSHIONED OPENINGS

(71) Applicant: Christian VAIDA, Heidenheim (DE)

(72) Inventor: Christian VAIDA, Heidenheim (DE)

(21) Appl. No.: 15/508,532

(22) PCT Filed: Sep. 8, 2014
(86) PCT No.: PCT/IB2014/001820

§ 371 Date: Mar. 3, 2017

(51) Int. Cl. G10D 13/02

(52) U.S. Cl. CPC G10D 13/022; G10D 13/027

(57) ABSTRACT

A drum head, particularly for bass drum, has rounded openings close to its outer margin, which are padded with U-shaped toroidal dampers of felt or open-cell plastic foam.

### FIELD OF INVENTION

The invention relates to drums and drumheads, here in particular to the bass drum, which is an essential part of modern drum kits. More closely, it pertains to the head of big drums like Bass drums and in it to the buildup of this head itself and particularly to cutouts in it, for to achieve special sound effects.

### Background of the Invention

When drum sets started to be used in Jazz and later in Rock music, the required sound effect of bass drum shifted from a grumbling rhythmic understructure, that mingled with plucked acoustic bass, to a predominantly kicking pitchy sound, that had to keep up with amplified electric guitars and electric bass. This was primarily achieved by use of new geometries in foot machines and harder beaters. But it soon turned out, that the resonance head of drums were a limiting factor, firstly due to back pressure of the enclosed air volume, but also due to the different resonant frequencies of the resonance head that came with it.

Fine tuning of the resonance head could enhance the effect, but in many cases damping became necessary. Playing without resonance head however resulted in a strong kick, but the fundamental was weak and its first harmonics where missing due to the missing resonance of the second head. So the fullness, the warmth and the impact of the sound were lacking.

### Prior Art

Muffling is mostly achieved with cushions inside the drum body as taught in U.S. Pat. No. 5,088,376, but frequently by just laying some cushion or blanket into the opening. But this did not solve the problem of back pressure. Therefore there had been attempts to optimize bass drum performance, first with holes in the drum body for to avoid the back pressure, later with cutting a hole into the the resonance head. However, a side effect of it was less articulated pitch due to vorticity or swirl at the edges of this opening. DE 1 248 448 therefore proposed a stabilizing band across the hole, which obviously did not solve the problem.

Other attempts, like implementing concentric rings of different reactance, as described in U.S. Pat. No. 4,244,266, obviously as well did not overcome the flaw. Moreover, rigidly framing the aperture, as U.S. Pat. No. 4,742,753 proposes, might stiffen the drum head around it but, due to secondary vibrations, must result in other unwanted effects and possibly therefore did not succeed.

Other attempts relate to tuned ports in closed baffles instead of resonance heads, as disclosed in U.S. Pat. No. 5,095,796. If correctly tuned to the air-mass of the enclosed volume and to the tension of the beater drumhead, an effective bass response may result. However, the kick of the beater necessarily will deteriorate.

Other propositions to muffle a drumhead, as in U.S. Pat. No. 7,498,499 B2, (originally intended for for muffling the beater drumhead) were administered in simple form—as with adhesive (“Gaffa”) tapes radially glued around cut-outs on resonance heads brought some relief, just like damper rings as proposed in U.S. Pat. No. 8,148,619 B1.

Pre-dampened bass drum heads with laminated rings at the outer margin of the head (Remo Powerstroke) or, even more successful, floating rings (Evans Patent DE 601 02 437 T2), have become a virtual standard. The reason is, that they shorten the sound effectively and a short bass drum sound is desired in faster music styles as we have today, for to distinguish the individual beats and let space for the other bass instruments. One disadvantage of these heads can be, that they eliminate too much of the harmonics, thus producing a somewhat dull sound.

### Task of the Invention

It is therefore task of the here disclosed invention to find means of improving a bass drum's sound through a sophisticated regulation of the fundamental and the first harmonics that bring a full sound with impact and the higher harmonics, that are necessary for the bass drum to be distinguished on small reproducing systems like smart phones.

### Inventive Step

The inventive step therefore is to open the drum volume in defined ports, equally distant on the outskirts of the drum head and to dampen the margins of these openings with medium-rigid plastic foam or felt inserts, having u-shaped cross section. The result is a balanced sound without the above-mentioned drawbacks.

### DESCRIPTION OF THE INVENTION

The head of a bass dum therefore has cutout holes, wherein dampers are inserted, that have a toroidal shape with a cutout ring, that encompasses the margins of the drumhead cutouts.

It was found that smaller holes and a closer position to the margin result in guarding more of the root sound, whereas a symmetric array gives more “tone” due to the fact, that the head can vibrate without interfering cross waves.

Even more important is the difference of this system to an attenuation on the margin itself, which deadens off too much of the overtones, which otherwise make the distinctive kicks that identify the bass drum within the orchestral sound.

Another effect of these openings is to give relief to the back pressure inside the beaten drum and thus to avoid the anticyclic effect of first driving the enclosed air mass, therewith in a phase-shifted manner driving the resonance head, that due to its tensioning results in another spectra of resonances that are emitted again as a sound mix.

### DESCRIPTION OF THE INVENTION ALONG TO THE DRAWINGS

FIG. 1 shows a simplified bassdrum 1 (without head tensioners) with the drum corpus 1, the rims that hold the drumheads 2 and 3, the resonance head 4 with a typical vibrational pattern 5, and an optional damping matress inside on the bottom 6. A series of said toroidal dampers 7 and its siblings, which enclose the holes cutout from the head to form venting ports with reduced turbulence and which are responsible for the gradually decreasing vibrational patterns 5 towards the drum head margins.

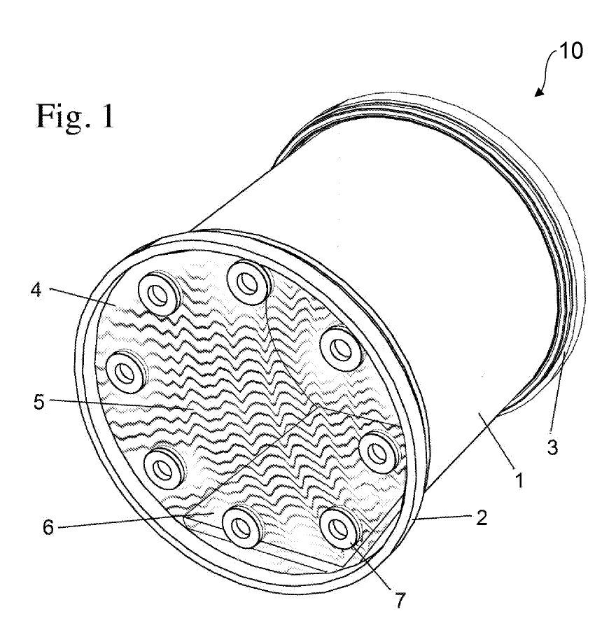

1. A drum head, comprising:
a plurality of cutouts, equally distant to the margin of the drum head; and
a cushion encompassing each cutout, made of medium-rigid, open-cell plastic foam damping material.

2. (canceled)

3. (canceled)

4. The drum head of claim 1, wherein said cushions are torus shaped with U-shaped cross section.

5. A drum head, comprising:
a plurality of cutouts, equally distant to the margin of the drum head; and
a cushion encompassing each cutout, made of felt composition damping material.

6. The drum head of claim 5, wherein said cushions are torus shaped with U-shaped cross section.
